(19) United States
(12) Patent Application Publication
(10) Pub. No.: US 2018/0284304 A1
(43) Pub. Date: Oct. 4, 2018

(54) Wellbore Distributed Acoustic Sensing System Using A Mode Scrambler

(71) Applicant: Halliburton Energy Services, Inc., Houston, TX (US)

(72) Inventors: David Barfoot, Houston, TX (US); Jason Edward Therrien, Cypress, TX (US); Lan Xinwei, Houston, TX (US); Yenny Natali Martinez, Houston, TX (US)

(21) Appl. No.: 15/570,488

(22) PCT Filed: Nov. 17, 2016
(86) PCT No.: PCT/US2016/062425

§ 371 Date: Oct. 30, 2017

(51) Int. Cl. G01V 1/22

(52) U.S. Cl. CPC G01V 1/226; G01V 2210/1429; G01V 2210/1234

(57) ABSTRACT

A wellbore distributed acoustic sensing system can include a mode scrambler and a multimode circulator. The mode scrambler can be coupled to a multimode optical fiber for outputting to the multimode optical fiber a multimode optical signal generated from a single-mode optical signal. The multimode circulator can be coupled to the multimode optical fiber for routing the multimode optical signal to a distributed acoustic sensing optical fiber positioned downhole in the wellbore. The multimode circulator can further be communicatively coupled to an optical receiver for routing a backscattered multimode optical signal received from the distributed acoustic sensing optical fiber to the optical receiver.

### TECHNICAL FIELD

The present disclosure relates generally to distributed acoustic sensing systems and, more particularly (although not exclusively), to a wellbore distributed acoustic sensing system using a mode scrambler.

### BACKGROUND

Distributed acoustic sensing technology may be suitable for various downhole applications ranging from temperature sensing to passive seismic monitoring. For example, a distributed acoustic sensing system may include an interrogation device positioned at a surface proximate to a wellbore and coupled to an optical sensing optical fiber extending from the surface into the wellbore. An optical source of the interrogation device may transmit an optical signal, or an interrogation signal, downhole into the wellbore through the optical sensing optical fiber. Backscattering can occur in response to the optical signal interacting with the optical fiber and can allow the optical signal to propagate back toward an optical receiver in the interrogation device and the backscattered optical signal can be analyzed to determine a condition in the wellbore.

### BRIEF DESCRIPTION OF THE DRAWINGS

FIG. 1 is a cross-sectional schematic diagram depicting an example of a wellbore environment including a distributed acoustic sensing system according to one aspect of the present disclosure.

FIG. 2 is a schematic diagram of an example of a distributed acoustic sensing system according to one aspect of the present disclosure.

FIG. 3 is a diagram of an example of an energy distribution of a single-mode coherent optical signal as it propagates through a multimode optical fiber according to one aspect of the present disclosure.

FIG. 4 is a diagram of an example of an energy distribution of a single-mode distributed optical signal as it propagates through a multimode optical fiber according to one aspect of the present disclosure.

FIG. 5 is a diagram of an example of an energy distribution of an optical signal having multiple modes as it propagates through a multimode optical fiber according to one aspect of the present disclosure.

FIG. 6 is a flow chart of an example of a process for operating a distributed acoustic sensing system using a mode scrambler according to one aspect of the present disclosure.

### DETAILED DESCRIPTION

Certain aspects and examples of the present disclosure relate to a wellbore distributed acoustic sensing system using a mode scrambler and a multimode circulator. A mode scrambler can distribute the energy of an optical signal by transmitting the optical signal into multiple modes. In some examples, a mode scrambler can generate a multimode optical signal for use as an interrogation signal from a single-mode optical signal. The multimode optical signal can be routed to a multimode optical fiber (e.g., a distributed acoustic sensing optical fiber) positioned downhole in a wellbore by a multimode circulator. The multimode circulator can further receive a backscatter of the multimode optical signal and route the backscattered light to an optical receiver, which can determine information about the wellbore or an environment of the wellbore based on the backscatter of the multimode optical signal.

In some aspects, the energy density of an interrogation signal can be reduced by the mode scrambler distributing the energy in the interrogation signal across multiple modes. Reducing the energy density of the interrogation signal can allow the distributed acoustic sensing system to transmit interrogation signals at a higher power without observing non-linear distortion. In additional or alternative aspects, increasing the power of the interrogation signal can increase the power of the backscattered signal, which can increase the signal-to-noise ratio (“SNR”) of the distributed acoustic sensing system.

In some examples, a rectangular pulse of an optical signal can be used for an interrogation signal. The pulse energy can be the product of the peak power duration (i.e., width) of the rectangular pulse. Increasing the pulse energy can occur by increasing the peak power or the pulse duration. But, there can be limitations on both the pulse duration and the peak power. In some examples, increasing the pulse width can reduce some parameters (e.g., the spatial resolution, the linearity, and the repeatability) of the distributed acoustic sensing measurements. To preserve these parameters, the pulse duration can be kept short (e.g., less than 100 ns). In additional or alternative examples, increasing the peak power can increase the optical power density within a distributed acoustic sensing optical fiber. As a high-power density pulse travels down the distributed acoustic sensing optical fiber, a non-linear interaction can occur and cause spectral broadening. The process of spectral broadening can cause the optical spectrum of the pulse to shift away from the center frequency, which can decrease the backscattered signal of interest. Since system noise will remain constant, this can cause degradation of the SNR. In additional or alternative aspects, a high-power density pulse can convert the energy to a slightly lower optical frequency and cause an increase in power attenuation.

In some examples, a single-mode optical fiber can directly couple an interrogation subsystem to a multimode sensing optical fiber. The interrogation subsystem can transmit an optical pulse to the single-mode optical fiber. The optical pulse can propagate through the single-mode fiber and enter the multimode sensing optical fiber through a splice or a connector. The optical pulse can propagate through the multimode sensing optical fiber using a single mode of the multimode fiber. For example, in graded-index multimode fiber the pulse energy can be primarily confined to the fundamental mode of the multimode fiber. Confinement of the pulse energy in the fundamental mode can result in the pulse energy propagating through only a portion of the diameter of the multimode fiber (e.g., 50 microns to 100 microns). In some examples, the energy density of a single-mode pulse travelling in a multimode fiber can be similar to a single-mode pulse travelling in single-mode fiber, which has a much smaller core diameter (e.g., around 9 microns).

Using a mode scrambler can transmit a single-mode optical signal into multiple modes of the multimode fiber. The mode scrambler can distribute the energy of the optical signal among multiple low loss modes. The mode scrambler can generate a multimode optical signal based on a single-mode optical signal and provide the lower density multimode optical signal as an interrogation signal for a distributed acoustic sensing optical fiber. Using the mode scrambler in a distributed acoustic sensing system can allow the system to transmit optical signals at a higher power and with a lower energy distribution, which can produce a higher SNR. In some examples, a mode stripper can be communicatively coupled to the mode scrambler for stripping an output of the mode scrambler of portions of the optical signal in high loss modes. In some aspects, a mode scrambler can be a device communicatively coupled to a multimode optical fiber. In additional or alternative aspects, the mode scrambler can be constructed by applying micro-bending to the multimode optical fiber to cause an optical signal propagating through the multimode optical fiber to split into multiple modes.

In some examples, a distributed acoustic sensing system using a mode scrambler can transmit a single-mode optical signal with a peak power of more than 2000 mW without observing non-linear distortion at the end of a 5 km optical fiber. The higher power of a backscattered optical signal can reduce the phase noise by over 3 dB compared to existing distributed acoustic sensing systems transmitting interrogation signals at power levels of 750 mW.

Detailed descriptions of certain examples are discussed below. These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. The various figures described below depict examples of implementations for the present disclosure, but should not be used to limit the present disclosure.

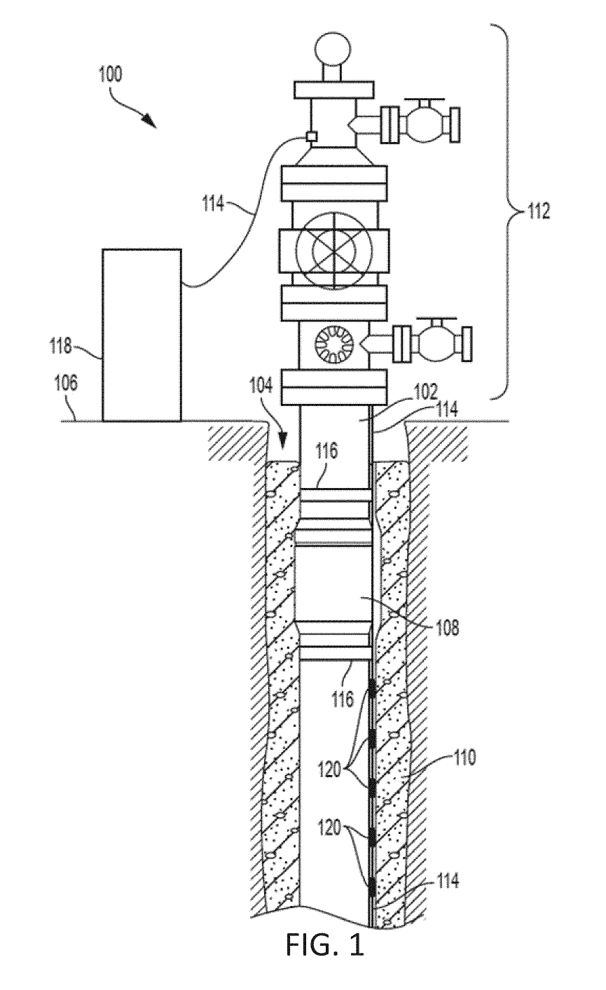

Various aspects of the present disclosure may be implemented in various environments. FIG. 1 illustrates an example of a wellbore environment 100 that may include a distributed acoustic sensing system according to some aspects of the present disclosure. The wellbore environment 100 includes a casing string 102 positioned in a wellbore 104 that has been formed in a surface 106 of the earth. The wellbore environment 100 may have been constructed and completed in any suitable manner, such as by use of a drilling assembly having a drill bit for creating the wellbore 104. The casing string 102 may include tubular casing sections connected by end-to-end couplings 108. In some aspects, the casing string 102 may be made of a suitable material such as steel. Within the wellbore 104, cement 110 may be injected and allowed to set between an outer surface of the casing string 102 and an inner surface of the wellbore 104. At the surface 106 of the wellbore 104, a tree assembly 112 may be joined to the casing string 102. The tree assembly 112 may include an assembly of valves, spools, fittings, etc. to direct and control the flow of fluid (e.g., oil, gas, water, etc.) into or out of the wellbore 104 within the casing string 102.

Optical fibers 114 may be routed through one or more ports in the tree assembly 112 and extend along an outer surface of the casing string 102. The optical fibers 114 can include multiple optical fibers. For example, the optical fibers 114 can include one or more single-mode optical fibers and one or more multimode optical fibers. Each of the optical fibers 114 may include one or more optical sensors 120 along the optical fibers 114. The sensors 120 may be deployed in the wellbore 104 and used to sense and transmit measurements of downhole conditions in the wellbore environment 100 to the surface 106. The optical fibers 114 may be retained against the outer surface of the casing string 102 at intervals by coupling bands 116 that extend around the casing string 102. The optical fibers 114 may be retained by at least two of the coupling bands 116 installed on either side of the couplings 108. In some aspects, the optical fibers 114 can be positioned exterior to the casing string 102, but other deployment options may also be implemented. For example, the optical fibers 114 can be coupled to a wireline or coiled tubing that can be positioned in an inner area of the casing string 102. The optical fibers 114 can be coupled to the wireline or coiled tubing such that the optical fibers 114 are removable with the wireline or coiled tubing. In additional or alternative examples, coupling bands can couple the optical fibers 114 to a production tubing positioned in the casing string 102 or an open hole wellbore.

The optical fibers 114 can be coupled to an interrogation subsystem 118 of a distributed acoustic sensing system. The interrogation subsystem 118 is positioned at the surface 106 of the wellbore 104. In some aspects, the interrogation subsystem 118 may be an opto-electronic unit that may include devices and components to interrogate sensors 120 coupled to the optical fibers 114. For example, the interrogation subsystem 118 may include an optical source, such as a laser device, that can generate optical signals to be transmitted through one or more of the optical fibers 114 to the sensors 120 in the wellbore 104. The interrogation subsystem 118 may also include an optical receiver to receive and perform interferometric measurements of backscattered optical signals from the sensors 120 coupled to the optical fibers 114.

Although FIG. 1 depicts the optical fibers 114 as being coupled to the sensors 120, the optical fibers 114 can form a distributed acoustic sensing optical fiber and operate as a sensor. A distributed acoustic sensing optical fiber can be remotely interrogated by transmitting an optical signal downhole through the optical fibers 114. In some examples, Rayleigh scattering from random variations of a refractive index in the optical waveguide can produce backscattered light. By measuring a difference in an optical phase of the scattering occurring at two locations along the optical fibers 114 and tracking changes in the phase difference over time, a virtual vibration sensor can be formed in the region between the two scattering location. By sampling the backscattered optical signals at a high rate (e.g., 100 MHz) the optical fibers 114 can be partitioned into an array of vibration sensors.

The power of backscattered signals can be very weak (e.g., −60 dB or lower relative to the peak power of the interrogation pulse) and the SNR of the distributed acoustic sensing measurements can depend on the power of the backscattered signals. In some examples, the power of the backscattered signals can be increased by increasing the power of the optical signals transmitted to the optical fibers 114. The power of the backscattered signal can also be increased when the backscattered signal uses more of the larger core size of the multimode fiber by distributing the energy of the signal across multiple modes. The distribution of the backscattered signal can be based on the distribution of the optical signal transmitted to the optical fibers 114. In some examples, the interrogation subsystem 118 can include a mode scrambler for distributing an energy in a single-mode optical signal across multiple modes prior to a multimode circulator routing the multimode optical signal to the optical fibers 114.

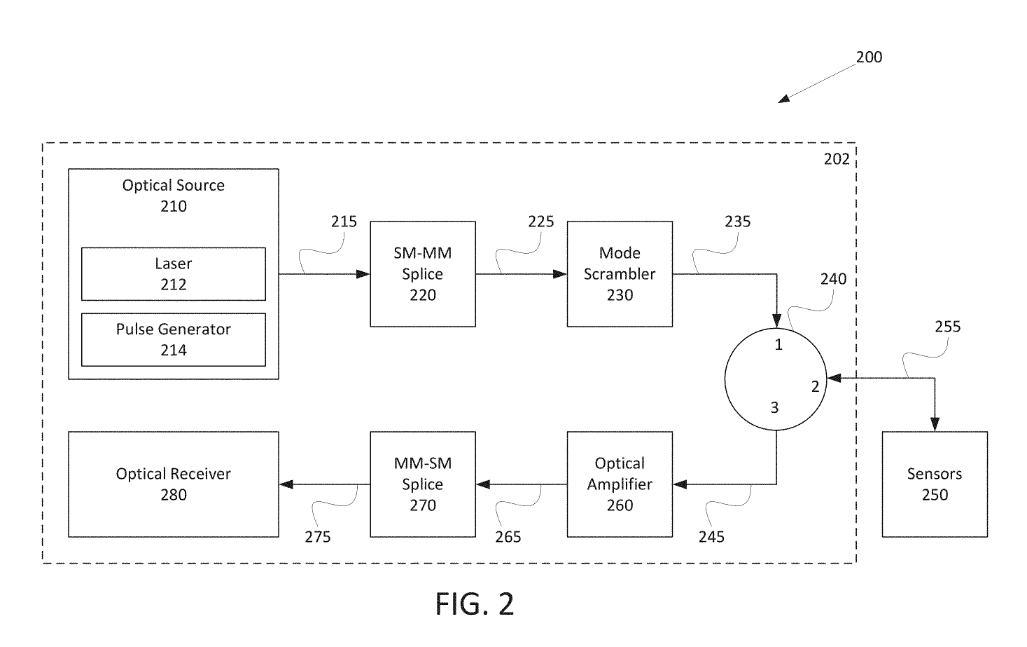

FIG. 2 is a schematic diagram of an example of a distributed acoustic sensing system 200 according to one aspect of the present disclosure. The distributed acoustic sensing system 200 includes an interrogation subsystem 202. In some aspects, the interrogation subsystem 202 of FIG. 2 represents one configuration of the interrogation subsystem 118 and the optical fibers 114 of FIG. 1, but other configurations are possible. For example, the components of the distributed acoustic sensing system 200 may be arranged in a different order or configuration without departing from the scope of the present disclosure. Similarly, one or more components may be added to or subtracted from the configuration of the distributed acoustic sensing system 200 shown in FIG. 2 without departing from the scope of the present disclosure.

The interrogation subsystem 202 may be positioned at a surface of a wellbore and the interrogation subsystem 202 includes an optical source 210. The optical source 210 includes a laser 212 and a pulse generator 214. The laser 212 can emit optical signals that can be manipulated by the pulse generator 214. For example, the pulse generator 214 may include an opto-electrical device acting as a high-speed shutter or optical switch to generate short pulses (e.g., 100 nanoseconds or less) of the optical signals emitted by the laser 212. In some aspects, the pulse generator 214 may include one or more amplifiers, oscillators, or other suitable components to manipulate the optical signals emitted by the laser 212 to generate pulses of optical signals at a controlled time duration. For example, a pulse may be a short pulse of the optical signal having a time duration based on the configuration and operation of the distributed acoustic sensing system.

The pulses of the optical signals from the pulse generator 214 may be transmitted to a single-mode optical fiber 215. The single-mode optical fiber 215 can include one or more optical fibers that propagate, or carry, optical signals in a direction that is parallel to the fiber (e.g., a traverse mode). In some aspects, the single-mode optical fiber 215 may include a core diameter between 8 and 10 microns. The single-mode optical fiber 215 can be coupled to a multimode optical fiber 225 by a single-mode-to-multimode splice 220.

The multimode optical fiber 225 can include one or more multimode optical fibers that can propagate optical signals in more than one mode. In some aspects, the core diameter of a multimode optical fiber (e.g., 50 microns to 100 microns) may be larger than the core diameter of a single-mode optical fiber. A larger core diameter can allow a multimode optical fiber to support multiple propagation modes.

The pulses of the optical signal can propagate through the single-mode optical fiber 215, the single-mode to multimode splice 220, and the multimode optical fiber 225 to arrive at the mode scrambler 230. The pulses of the optical signals can propagate through the multimode optical fiber 225 as coherent optical signals such that the mode scrambler 230 receives optical signals in a single-mode form. The mode scrambler 230 may include a device that includes a mode mixer for providing a modal distribution of optical signals. For example, the mode scrambler 230 may receive a single-mode optical signal from the optical source 210 and generate a multimode optical signal that uses multiple modes, or patterns, of the single-mode optical signal. Each mode of the multimode optical signal may propagate an optical path in a different direction. The multimode optical signal may be output by the mode scrambler 230 through a multimode optical fiber 235 to a multimode circulator 240.

The multimode circulator 240 can be a three-port multimode circulator 240 including ports 1 to 3. The multimode circulator 240 may include one or more isolation components to isolate the input of the optical signals at each of the ports 1 to 3. Port 1 is communicatively coupled to the output of the mode scrambler 230 by the second multimode optical fiber 235 for receiving the multimode optical signal from the mode scrambler 230. The multimode circulator 240 may also be optically transparent. For example, the multimode circulator 240 may operate in a passband wavelength range to allow optical signals to be routed through the multimode circulator 240 without being scattered, in an optically transparent manner.

The multimode circulator 240 may route the multimode optical signal from port 1 to port 2. Port 2 is communicatively coupled to a distributed acoustic sensing optical fiber 255, which can be positioned in the wellbore 104. The multimode optical signals can be output from port 2 to the distributed acoustic sensing optical fiber 255 to interrogate the sensors 250 coupled to the distributed acoustic sensing optical fiber 255. Port 2 may receive backscattered multimode optical signals. The backscattered multimode optical signals may correspond to backscattering of the multimode optical signals transmitted through the distributed acoustic sensing optical fiber 255 to the sensors 250. For example, the multimode optical signals may be routed by the distributed acoustic sensing optical fiber 255 to the sensors 250 and backscattered back through the distributed acoustic sensing optical fiber 255 to port 2. Port 2 may route the backscattered multimode optical signals to port 3. The unilateral nature of the multimode circulator 240 can prevent the backscattered optical signal from the sensors 250 from propagating back toward the mode scrambler 230.

Port 3 of the multimode circulator 240 is coupled to a multimode optical fiber 245, which communicatively couples port 3 to an optical amplifier 260. The optical amplifier 260 can include an erbium-doped fiber amplifier (“EDFA”) that may amplify a received optical signal without first converting the optical signal to an electrical signal. For example, an EDFA may include a core of a silica fiber that is doped with erbium ions to cause the wavelength of a received optical signal to experience a gain to amplify the intensity of an outputted optical signal. Although only one optical amplifier 260 is shown in FIG. 2, the optical amplifier 260 may represent multiple amplifiers without departing from the scope of the present disclosure.

An output of the optical amplifier 260 can be coupled to a multimode optical fiber 265. The multimode optical fiber 265 can be coupled to a single-mode optical fiber 275 by a multimode to single-mode splice 270. The amplified backscattered multimode optical signal can be received by an optical receiver 280 by propagating from the output of the optical amplifier 260, through the multimode optical fiber 265, through the multimode to single-mode splice 270, and through the single-mode optical fiber 275.

In some aspects, the optical receiver 280 may include opto-electrical devices having one or more photodetectors to convert optical signals into electricity using a photoelectric effect. In some aspects, the photodetectors include photodiodes to absorb photons of the optical signals and convert the optical signals into an electrical current. In some aspects, the electrical current may be routed to a computing device for analyzing the optical signals to determine a condition of the wellbore 104. Although one optical receiver 280 is shown in FIG. 2, the optical receiver 280 may represent multiple optical receivers for receiving optical signals backscattered from the sensors 250.

Although FIG. 2 depicts the optical source 210 and optical receiver 280 as transmitting and receiving single-mode optical signals respectively, other arrangements are possible. For example, the optical receiver 280 can be directly coupled to the multimode optical fiber 265 and an amplified backscattered multimode optical signal can propagate over the multimode optical fiber 265 to the optical receiver 280. In some aspects, the optical source 210 and optical receiver 280 can be included in a single device communicatively coupled to a bidirectional port of another multimode circulator. The bidirectional port of the additional multimode circulator can receive emitted optical signals from the single device and route the emitted single-mode optical signals through a second port towards the mode scrambler 230. A third port can receive a backscattered multimode optical signal and route the backscattered signal through the bidirectional port to the single device. In some aspects, the mode scrambler 230 can include (or be communicatively coupled to) a mode stripper. The mode stripper can remove predetermined modes from the multimode optical signal. In some examples, the predetermined modes include modes that have are determined to be leaky and have a high attenuation value.

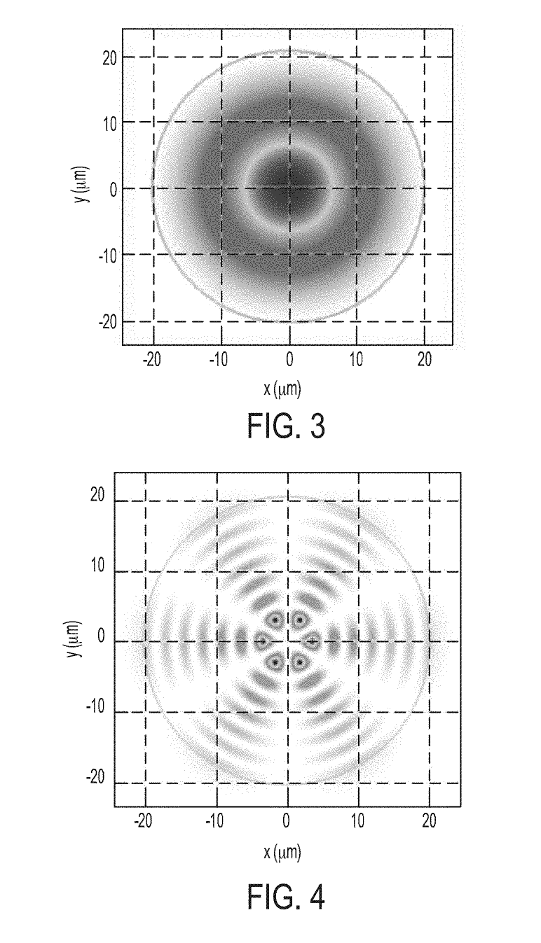

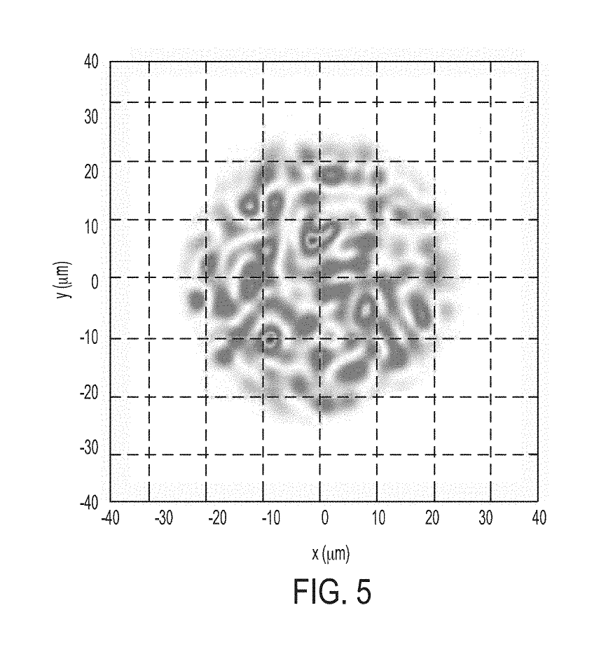

FIGS. 3-5 depict examples of energy distributions of optical signals propagating through a multimode optical fiber. Each of FIGS. 3-4 depict an energy distribution for a single-mode optical signal propagating through a multimode optical fiber. FIG. 3 depicts a coherent single-mode optical signal and FIG. 4 depicts a distributed single-mode optical signal. FIG. 3 can depict an energy distribution of the single-mode optical signal generated by the optical source 210 propagating through the multimode optical fiber 225. FIG. 5 depicts an energy distribution of a multimode optical signal propagating in multiple modes of a multimode optical fiber. FIG. 5 can depict an energy distribution of the multimode optical signal propagating through the multimode optical fiber 235.

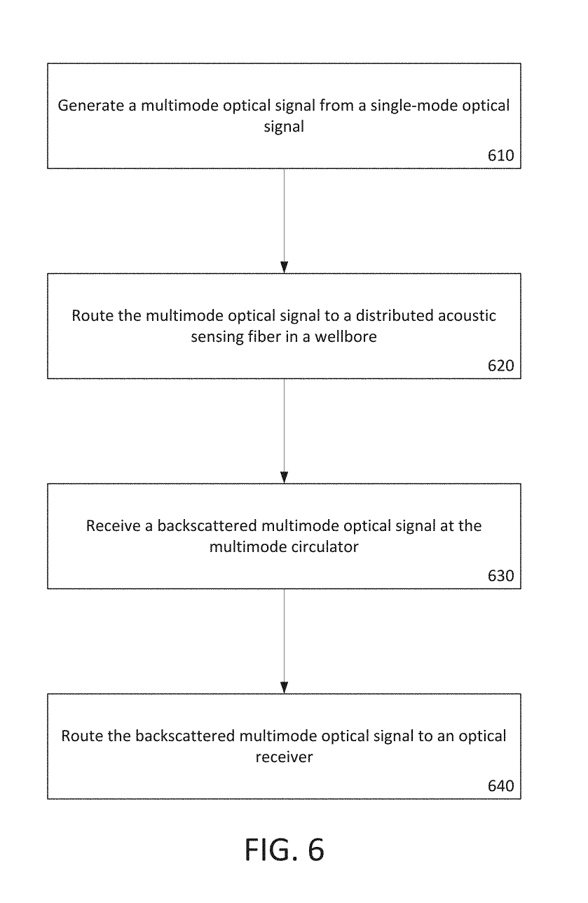

FIG. 6 is a flow chart of an example of a process for operating a wellbore distributed acoustic sensing system using a mode scrambler. The process is described with respect to the wellbore environment 100 of FIG. 1 and the distributed acoustic sensing system 200 of FIG. 2, unless otherwise specified, though other implementations are possible without departing form the scope of the present disclosure.

In block 610, a multimode optical signal is generated from a single-mode optical signal. In some examples, a single-mode optical can be generated by the optical source 210 and propagate through the single-mode optical fiber 215. The single-mode optical signal can further propagate through the multimode optical fiber 225 spliced to the single-mode optical fiber 215. The single-mode optical signal can remain a coherent signal as the single-mode optical signal propagates through the multimode optical fiber 225 to the mode scrambler 230. The mode scrambler 230 can generate a multimode optical signal by transmitting the single-mode optical signal into multiple modes supported by the multimode optical fiber 235. The mode scrambler 230 can distribute the energy across the diameter of the multimode optical fiber 235 reducing the energy density of the multimode optical signal relative to the single-mode optical signal. The multimode optical signal can propagate through the multimode optical fiber 235 to port 1 of the multimode circulator 240.

In block 620, the multimode optical signal is routed to a distributed acoustic sensing optical fiber 255 in a wellbore 104. In some examples, the multimode optical signal can be received at the port 1 of the multimode circulator 240 and routed out through port 2 of the multimode circulator 240. Port 2 can be coupled to the distributed acoustic sensing optical fiber 255 such that the multimode optical signal is routed to the distributed acoustic sensing optical fiber 255. The multimode circulator 240 can be optically transparent such that the multimode circulator 240 can operate in a passband wavelength range to allow optical signals to be routed through the multimode circulator 240 without being scattered.

In block 630, a backscattered multimode optical signal is received by the multimode circulator 240. In some examples, the multimode optical signal can propagate downhole through the distributed acoustic sensing optical fiber 255 and a backscattered multimode optical signal, can be generated and propagate uphole to the multimode circulator 240. In some examples, the backscattered multimode optical signal can be generated by the sensors 250 in response to receiving the multimode optical signal. The sensors 250 can generate the backscattered multimode optical signal based on features of the wellbore 104 or the wellbore environment 100.

In additional or alternative examples, the backscattered multimode optical signal can be generated by the multimode optical signal traversing the distributed acoustic sensing optical fiber 255, which can operate as a virtual vibration sensor. The backscattered multimode optical signal can be received at the port 2 of the multimode circulator 240, which can operate in unilateral direction to prevent the backscattered multimode optical signal propagating toward the port 1 and the mode scrambler 230.

In block 640, the backscattered multimode optical signal is routed to an optical receiver 280. In some examples, the backscattered multimode optical signal can be routed from the port 2 through the port 3 of the multimode circulator 240. The backscattered multimode optical signal can propagate through the multimode optical fiber 245 coupled to port 3 of the multimode circulator 240. In some examples, the multimode optical fiber 245 can be directly coupled to the optical receiver 280, which can be configured to receive a multimode optical signal. In additional or alternative examples, the multimode optical fiber 245 can be coupled to an optical amplifier 260.

The optical amplifier 260 can include an erbium-doped fiber amplifier (“EDFA”) that may amplify a received optical signal without first converting the optical signal to an electrical signal. For example, an EDFA may include a core of a silica fiber that is doped with erbium ions to cause the wavelength of a received optical signal to experience a gain to amplify the intensity of an outputted optical signal. The output of the optical amplifier 260 can be coupled to the multimode optical fiber 265.

The multimode optical fiber 265 can be spliced to the single-mode optical fiber 275, which can be coupled to the optical receiver 280 such that the amplified backscattered multimode optical signal can propagate through a single-mode optical fiber before being received at the optical receiver 280. The optical receiver 280 can analyze the received signal and compare the received signal with other received signals to determine information about the wellbore 104 or the wellbore environment 100.

In some aspects, systems and methods may be provided according to one or more of the following examples:

### Example #1

A system can include a mode scrambler and a multimode circulator. The mode scrambler can be coupled to a multimode optical fiber for outputting to the multimode optical fiber a multimode optical signal generated from a single-mode optical signal. The multimode circulator can be coupled to the multimode optical fiber for routing the multimode optical signal to a distributed acoustic sensing optical fiber positioned downhole in a wellbore. The multimode circulator can also be communicatively coupled to an optical receiver for routing a backscattered multimode optical signal received from the distributed acoustic sensing optical fiber to the optical receiver.

### Example #2

The system of Example #1, further including a distributed acoustic sensing subsystem positioned downhole in the wellbore. The distributed acoustic sensing subsystem including the distributed acoustic sensing optical fiber for receiving the multimode optical signal and generating the backscattered multimode optical signal based on a feature of an environment of the wellbore in response to receiving the multimode optical signal.

### Example #3

The system of Example #1, further featuring the multimode optical fiber being a first multimode optical fiber. The system can further include an optical source for generating the single-mode optical signal and transmitting the single-mode optical signal into a single-mode optical fiber. The single-mode optical fiber can be spliced to a second multimode optical fiber that can be communicatively coupled to the mode scrambler.

### Example #4

The system of Example #3, further featuring the mode scrambler being communicatively coupled to the optical source for generating the multimode optical signal with a lower energy density than the single-mode optical signal.

### Example #5

The system Example #1, further featuring the multimode circulator including a first port, a second port, and a third port. The first port can be communicatively coupled to the mode scrambler for receiving the multimode optical signal. The second port can be communicatively coupled to the distributed acoustic sensing optical fiber for routing the multimode optical signal to the distributed acoustic sensing optical fiber and for receiving the backscattered multimode optical signal. The third port can be communicatively coupled to the optical receiver for routing the backscattered multimode optical signal to the optical receiver.

### Example #6

The system of Example #5, further featuring the multimode optical fiber being a first multimode optical fiber. The third port can be coupled to a second multimode optical fiber that can be spliced to a single-mode optical fiber using an adiabatic taper. The single-mode optical fiber can be coupled to the optical receiver. The system can further include an optical amplifier communicatively coupled between the third port of the multimode circulator and the single-mode optical fiber for amplifying the backscattered multimode optical signal.

### Example #7

The system of Example #1, further featuring the mode scrambler including a mode-stripping device for removing a portion of the multimode optical signal having a predetermined mode.

### Example #8

The system of Example #1, further including the optical receiver communicatively coupled to the multimode circulator for receiving the backscattered multimode optical signal and for determining information about an environment of the wellbore based on the backscattered multimode optical signal.

### Example #9

The system of Example #1, further featuring the mode scrambler and the multimode circulator being part of an interrogation subsystem or a distributed acoustic sensing system and being positioned at a surface of the wellbore for monitoring features of a wellbore environment.

### Example #10

A method can include generating, by a mode scrambler, a multimode optical signal from a single-mode optical signal. The method can further include routing, by a multimode circulator communicatively coupled to the mode scrambler, the multimode optical signal through a distributed acoustic sensing optical fiber positioned in a wellbore. The method can further include receiving, by the multimode circulator, a backscattered multimode optical signal on the distributed acoustic sensing optical fiber in response to routing the multimode optical signal through the distributed acoustic sensing optical fiber. The method can further include routing, by the multimode circulator, the backscattered multimode optical signal to an optical receiver.

### Example #11

The method of Example #10, further including receiving, by the mode scrambler, the single-mode optical signal from an optical source via a single-mode optical fiber coupled to the optical source and spliced to a multimode optical fiber coupled to the mode scrambler.

### Example #12

The method of Example #10, further featuring generating the multimode optical signal further including distributing an energy in the single-mode optical signal across multiple modes such that the multimode optical signal has a lower energy density than the single-mode optical signal.

### Example #13

The method of Example #10, further featuring routing the multimode optical signal through the distributed acoustic sensing optical fiber including receiving the multimode optical signal at a first port communicatively coupled to the mode scrambler. Routing the multimode optical signal through the distributed acoustic sensing optical fiber an further include routing the multimode optical signal through a second port communicatively coupled to the distributed acoustic sensing optical fiber. Receiving the backscattered multimode optical signal can further include receiving the backscattered multimode optical signal at the second port. Routing the backscattered multimode optical signal can include routing the backscattered multimode optical signal through a third port communicatively coupled to the optical receiver.

### Example #14

The method of Example #13, further featuring routing the backscattered multimode optical signal including routing the backscattered multimode optical signal to an optical amplifier that amplifies the backscattered multimode optical signal and transmits an amplified the backscattered multimode optical signal over a multimode optical fiber having an adiabatic taper that splices the multimode optical fiber to a single-mode optical fiber that can be coupled to the optical receiver.

### Example #15

The method of Example #10, further including removing, by the mode scrambler, a portion of the multimode optical signal having a predetermined mode using a stripping device.

### Example #16

A system can include a distributed acoustic sensing subsystem, a multimode circulator, and a mode scrambler. The distributed acoustic sensing subsystem can be positioned downhole in a wellbore. The distributed acoustic sensing system can include a multimode optical fiber as a communication medium for an interrogation optical signal and a backscattered optical signal. The multimode circulator can be coupled to the multimode optical fiber to route the interrogation optical signal toward the distributed acoustic sensing subsystem and to route the backscattered optical signal toward an optical receiver. The mode scrambler can be communicatively coupled to the multimode circulator for generating the interrogation optical signal from a single-mode optical signal.

### Example #17

The system of Example #16, further featuring the distributed acoustic sensing subsystem being positioned downhole in the wellbore for receiving the interrogation optical signal and generating the backscattered optical signal based on a feature of an environment of the wellbore.

### Example #18

The system of Example #16, further featuring the multimode optical fiber can be a first multimode optical fiber. The system can further include an optical source and the optical receiver. The optical source can be for generating the single-mode optical signal and transmitting the single-mode optical signal into a single-mode optical fiber. The single-mode optical fiber can be spliced to a second multimode optical fiber that can be coupled to the mode scrambler. The optical receiver can be communicatively coupled to the multimode circulator for receiving the backscattered optical signal and for determining information about an environment of the wellbore based on the backscattered optical signal.

### Example #19

The system of Example #16, further featuring the multimode optical fiber being a first multimode optical fiber. The multimode circulator can be coupled to a second multimode optical fiber that can be spliced to a single-mode optical fiber using an adiabatic taper. The single-mode optical fiber can be coupled to the optical receiver. The system can further include an optical amplifier communicatively coupled between the multimode circulator and the single-mode optical fiber for amplifying the backscattered optical signal.

### Example #20

The system of Example #16, further featuring the mode scrambler being communicatively coupled to the optical source for generating a multimode optical signal that has a lower energy density than the single-mode optical signal.

The foregoing description of the examples, including illustrated examples, has been presented only for the purpose of illustration and description and is not intended to be exhaustive or to limit the subject matter to the precise forms disclosed. Numerous modifications, adaptations, uses, and installations thereof can be apparent to those skilled in the art without departing from the scope of this disclosure. The illustrative examples described above are given to introduce the reader to the general subject matter discussed here and are not intended to limit the scope of the disclosed concepts.

What is claimed is:

1. A system, comprising:
a mode scrambler coupleable to a multimode optical fiber for outputting to the multimode optical fiber a multimode optical signal generated from a single-mode optical signal; and
a multimode circulator coupleable to the multimode optical fiber for routing the multimode optical signal to a distributed acoustic sensing optical fiber positionable downhole in a wellbore and communicatively coupleable to an optical receiver for routing a backscattered multimode optical signal received from the distributed acoustic sensing optical fiber to the optical receiver.

2. The system of claim 1, further comprising a distributed acoustic sensing subsystem positionable downhole in the wellbore, the distributed acoustic sensing subsystem including the distributed acoustic sensing optical fiber for receiving the multimode optical signal and generating the backscattered multimode optical signal based on a feature of an environment of the wellbore in response to receiving the multimode optical signal.

3. The system of claim 1, wherein the multimode optical fiber is a first multimode optical fiber, the system further comprising an optical source for generating the single-mode optical signal and transmitting the single-mode optical signal into a single-mode optical fiber, wherein the single-mode optical fiber is spliced to a second multimode optical fiber that is communicatively coupleable to the mode scrambler.

4. The system of claim 3 wherein the mode scrambler is communicatively coupleable to the optical source for generating the multimode optical signal with a lower energy density than the single-mode optical signal.

5. The system of claim 1, wherein the multimode circulator comprises:
a first port communicatively coupleable to the mode scrambler for receiving the multimode optical signal;
a second port communicatively coupleable to the distributed acoustic sensing optical fiber for routing the multimode optical signal to the distributed acoustic sensing optical fiber and for receiving the backscattered multimode optical signal; and
a third port communicatively coupleable to the optical receiver for routing the backscattered multimode optical signal to the optical receiver.

6. The system of claim 5, wherein the multimode optical fiber is a first multimode optical fiber, wherein the third port is coupleable to a second multimode optical fiber that is spliced to a single-mode optical fiber using an adiabatic taper, wherein the single-mode optical fiber is coupleable to the optical receiver, the system further comprising an optical amplifier communicatively coupleable between the third port of the multimode circulator and the single-mode optical fiber for amplifying the backscattered multimode optical signal.

7. The system of claim 1, wherein the mode scrambler comprises a mode-stripping device for removing a portion of the multimode optical signal having a predetermined mode.

8. The system of claim 1, further comprising the optical receiver communicatively coupleable to the multimode circulator for receiving the backscattered multimode optical signal and for determining information about an environment of the wellbore based on the backscattered multimode optical signal.

9. The system of claim 1, wherein the mode scrambler and the multimode circulator are part of an interrogation subsystem or a distributed acoustic sensing system and are positionable at a surface of the wellbore for monitoring features of a wellbore environment.

10. A method, comprising:
generating, by a mode scrambler, a multimode optical signal from a single-mode optical signal;
routing, by a multimode circulator communicatively coupled to the mode scrambler, the multimode optical signal through a distributed acoustic sensing optical fiber positioned in a wellbore;
receiving, by the multimode circulator, a backscattered multimode optical signal on the distributed acoustic sensing optical fiber in response to routing the multimode optical signal through the distributed acoustic sensing optical fiber; and
routing, by the multimode circulator, the backscattered multimode optical signal to an optical receiver.

11. The method of claim 10, further comprising:
receiving, by the mode scrambler, the single-mode optical signal from an optical source via a single-mode optical fiber coupled to the optical source and spliced to a multimode optical fiber coupled to the mode scrambler.

12. The method of claim 10, wherein generating the multimode optical signal further comprises distributing an energy in the single-mode optical signal across multiple modes such that the multimode optical signal has a lower energy density than the single-mode optical signal.

13. The method of claim 10, wherein routing the multimode optical signal through the distributed acoustic sensing optical fiber comprises:
receiving the multimode optical signal at a first port communicatively coupled to the mode scrambler; and
routing the multimode optical signal through a second port communicatively coupled to the distributed acoustic sensing optical fiber,
wherein receiving the backscattered multimode optical signal comprises receiving the backscattered multimode optical signal at the second port,
wherein, routing the backscattered multimode optical signal comprises routing the backscattered multimode optical signal through a third port communicatively coupled to the optical receiver.

14. The method of claim 13, wherein routing the backscattered multimode optical signal comprises routing the backscattered multimode optical signal to an optical amplifier that amplifies the backscattered multimode optical signal and transmits an amplified the backscattered multimode optical signal over a multimode optical fiber having an adiabatic taper that splices the multimode optical fiber to a single-mode optical fiber that is coupled to the optical receiver.

15. The method of claim 10, further comprising removing, by the mode scrambler, a portion of the multimode optical signal having a predetermined mode using a stripping device.

16. A system comprising:
a distributed acoustic sensing subsystem positionable downhole in a wellbore and that includes a multimode optical fiber as a communication medium for an interrogation optical signal and a backscattered optical signal;
a multimode circulator coupleable to the multimode optical fiber to route the interrogation optical signal toward the distributed acoustic sensing subsystem and to route the backscattered optical signal toward an optical receiver; and
a mode scrambler communicatively coupleable to the multimode circulator for generating the interrogation optical signal from a single-mode optical signal.

17. The system of claim 16, the distributed acoustic sensing subsystem is positionable downhole in the wellbore for receiving the interrogation optical signal and generating the backscattered optical signal based on a feature of an environment of the wellbore.

18. The system of claim 16, wherein the multimode optical fiber is a first multimode optical fiber, the system further comprising:
an optical source for generating the single-mode optical signal and transmitting the single-mode optical signal into a single-mode optical fiber, wherein the single-mode optical fiber is spliced to a second multimode optical fiber that is coupleable to the mode scrambler; and
the optical receiver communicatively coupleable to the multimode circulator for receiving the backscattered optical signal and for determining information about an environment of the wellbore based on the backscattered optical signal.

19. The system of claim 16, wherein the multimode optical fiber is a first multimode optical fiber, wherein the multimode circulator is coupleable to a second multimode optical fiber that is spliced to a single-mode optical fiber using an adiabatic taper, wherein the single-mode optical fiber is coupleable to the optical receiver, the system further comprising an optical amplifier communicatively coupleable between the multimode circulator and the single-mode optical fiber for amplifying the backscattered optical signal.

20. The system of claim 16, wherein the mode scrambler is communicatively coupleable to an optical source for generating a multimode optical signal that has a lower energy density than the single-mode optical signal.
